(19) United States
(12) Patent Application Publication
(10) Pub. No.: US 2008/0295121 A1
(43) Pub. Date: Nov. 27, 2008

(54) Compressible media disk storage trays

(76) Inventor: David Walter Muhonen, Costa Mesa, CA (US)

Correspondence Address: QUICKPATENTS, INC., 32861 CALLE PERFECTO, SUITE A, SAN JUAN CAPISTRANO, CA, 92675, US

(21) Appl. No.: 12/057,238

(22) Filed: Mar. 27, 2008

Related U.S. Application Data
(60) Provisional application No. 60/940,331, filed on May 25, 2007.

(51) Int. Cl. G11B 17/03

(52) U.S. Cl. 720/600

(57) ABSTRACT

A tray for storing a media disk is disclosed, the tray nestable and compressible with other such trays such that a stack of such trays may be snapped together, each tray capturing at least one of the media disks therein. Each tray holds at least one media disk such that a data portion of each media disk does not contact either the tray into which the disk is fixed, or the next adjacent tray in the stack of trays. As each tray is made from a resilient plastic material, each media disk is cushioned and protected from impacts and shock if the tray or the stack of trays are dropped. A U-shaped edge portion of each tray acts like a dampening spring to absorb impact to the tray, such as if dropped, for example.

### CROSS-REFERENCE TO RELATED APPLICATIONS

This application claims the benefit of U.S. Provisional Patent Application 60/940,331, filed on May 25, 2007, and incorporated herein by reference.

### STATEMENT REGARDING FEDERALLY SPONSORED RESEARCH AND DEVELOPMENT

Not Applicable.

### FIELD OF THE INVENTION

This invention relates to media storage, and more particularly to a novel compressible media storage system.

### DISCUSSION OF RELATED ART

Media storage systems are known in the art that hold one or more media disks, such as compact disks, CD-ROMs, DVDs, and the like. Many such storage systems are designed for use with the individual cases that are common with such media disks, such as CD jewel cases, DVD cases, and the like. Such systems are not well-suited for situations requiring compacted storage of such media disks.

Traditional CD jewel cases or DVD cases include hard shells that have top and bottom portions surrounding the media. These traditional approaches provide protection to the media from damage, however they have several drawbacks. One such drawback is that collections of CDs or DVDs can be hundreds or even thousands of items and the thickness of these cases can quickly multiply to take up a large volume of space. Another drawback is these devices are often made of rigid or semi-rigid material that can be easily broken if dropped. Thus, a device is needed that can protect media disks, yet does so in a spatially efficient manner and is not prone to breaking when dropped.

Some storage systems known in the art are useful for more compact storage of such media disks, but are inconvenient to use. For example, to access a particular disk in a compact library of 50 such disks, some storage devices require the user to move a lever to a number corresponding to the disk. US Patent Application US 2006/0187771 by Elbaum on Aug. 24, 2006 teaches such a device. Such systems tend to be made of rigid plastic, which is easily broken if dropped. Further, such storage systems are relatively expensive as they are made from a large number of different molded parts, springs, hinge pins, and the like. Still further, such storage devices provide for storing only a fixed number of disks, and require additional such devices to be purchased and used if a person's library exceeds the storage limit of such devices. Therefore a device is needed that provides a resilient, economical, and easily expandable solution for storage of media disks.

Several storage systems known in the art provide devices that can be expanded incrementally. For example, U.S. Pat. No. 6,568,526 to Reinhardt et al. on May 27, 2003 and U.S. Pat. No. 7,051,871 to Loritz on May 30, 2006 teach such devices. However, these devices still have the drawback of being prone to breaking if dropped and require traditional molds to manufacture, increasing production costs. Therefore, a device is needed that provides some additional measure of protection from damage if dropped. Also, as thousands of media disks may need to be stored, a device is needed that is very inexpensive to manufacture such as a single molded or vacuum-formed piece.

U.S. Pat. No. 6,837,374 B2 to Nigg et al. on Jan. 4, 2005 teaches a stackable container for supporting a film frame. The Nigg et al. device can be thermally formed or vacuum molded from a single sheet of material. However, unlike film frames stored by the Nigg et al. device, media disks often need to be quickly and efficiently accessed. The Nigg et al. device does not teach a way to quickly access a container when storing a large number of media disks. Therefore, a media storage device is needed that can provide ready access to any particular desired media disk, yet still maintain low manufacturing costs.

Another economical approach to storing media disks are sleeves or envelopes. These provide an economical solution, both financially and spatially, to storing media disks. However, such items contact all sides of the media disk including the data side of the media disk. This causes the data side of the media disk to be in direct contact with the material of the sleeve or envelope, risking damage to the data side. Moreover, this approach does not allow multiple media disks to be stored together without some kind of additional device to hold the sleeves or envelopes.

Therefore, there is a need for a compact storage system for media disks that is extremely inexpensive to manufacture, only requires a single molded or vacuum-formed piece, and is not prone to breaking if dropped. Further, such a needed system would protect the data portion of each disk so stored, and provide ready access to any particular desired disk. Further, such a needed device would be easily expanded to any number of disks, allowing a single storage system to be used and grown as a person's disk library grows. The present invention accomplishes these objectives.

### SUMMARY OF THE INVENTION

The present device is a tray for storing a media disk, such as a DVD, compact disc, CD-ROM, or the like. The media disk is preferably of the type having a data portion, a central hub, a top surface and an outer peripheral edge.

The tray comprises a top surface, a bottom surface, and at least one peripheral edge connecting the top and bottom surfaces. A generally U-shaped edge portion of the tray includes an outer side, an upper side, and an inner side. The inner side forms a resilient, generally annular wall that includes a lower trough that has a valley with a larger diameter than the diameter of the media disk. The lower trough has at least one ridge with a diameter that is smaller than the diameter of the media disk. As such, the media disk may be selectively captured within the lower trough of the tray, the outer side and the inner side of the U-shaped edge portion each being slightly tapered towards the upper side such that a plurality of the trays may be nestably stacked together.

In the preferred mode of the invention, the inner side of the U-shaped edge portion of the tray further includes an upper trough having a valley with a larger diameter than the diameter of the valley of the lower trough. Further, the upper trough has an upper ridge that has a diameter that is smaller than the diameter of the valley of the lower trough. As such, the upper trough of the tray may selectively receive the lower trough of another such tray therein in a nested, selectively locked stack of such trays. Each such stacked tray may include at least one media disk captured between successive trays. In this way a storage system for a plurality of the media disks that comprises a plurality of the trays may be formed.

In an alternate embodiment of the invention, each tray further includes a resilient media index portion projecting away from the peripheral edge of the tray at the outer side of the U-shaped edge portion. The media index portion includes an area adapted to receive markings thereon for indicating the characteristics, such as contents, of the media disk.

The present invention provides a compact storage system for media disks that is extremely inexpensive to manufacture, only requires a single molded or vacuum-formed piece, and is not prone to breaking if dropped. Further, the present system protects the data portion of each disk so stored, and provide ready access to any particular desired disk. Moreover, the present device is easily expanded to any number of disks, allowing a single storage system to be used and grown as a person's disk library grows. Multiple media disks may be stored together in a compressed stack of such devices, not requiring any additional racks or support structures. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of a media disk storage tray of the present invention;

FIG. 2 is a top plan view of the tray of the present invention;

FIG. 3 is a partial cross-sectional view of the invention, taken generally along lines 3-3 of FIG. 1, illustrating two of the trays of the invention stacked in an uncompressed configuration;

FIG. 4 is a partial cross-sectional view of the invention, taken generally along lines 3-3 of FIG. 1, illustrating two of the trays of the invention stacked in a compressed configuration;

FIG. 5 is a partial cross-sectional view of the invention, taken generally along lines 3-3 of FIG. 1, illustrating an annular trough optionally formed in the tray;

FIG. 6 is a perspective view of a stack of the trays of the present invention in the compressed configuration, and further illustrating an optional index portion of each tray;

FIG. 7 is a perspective view of the invention, illustrating an embodiment with an envelope;

FIG. 8 is a perspective view of the present invention, illustrating an optional index portion;

FIG. 9 is a perspective view of an alternate embodiment of the invention;

FIG. 10 is a cross-sectional view of the embodiment of FIG. 9, taken generally along lines 10-10 of FIG. 9; and

FIG. 11 is a partial side elevational view of an alternate embodiment of the invention.

### DETAILED DESCRIPTION OF THE PREFERRED EMBODIMENT

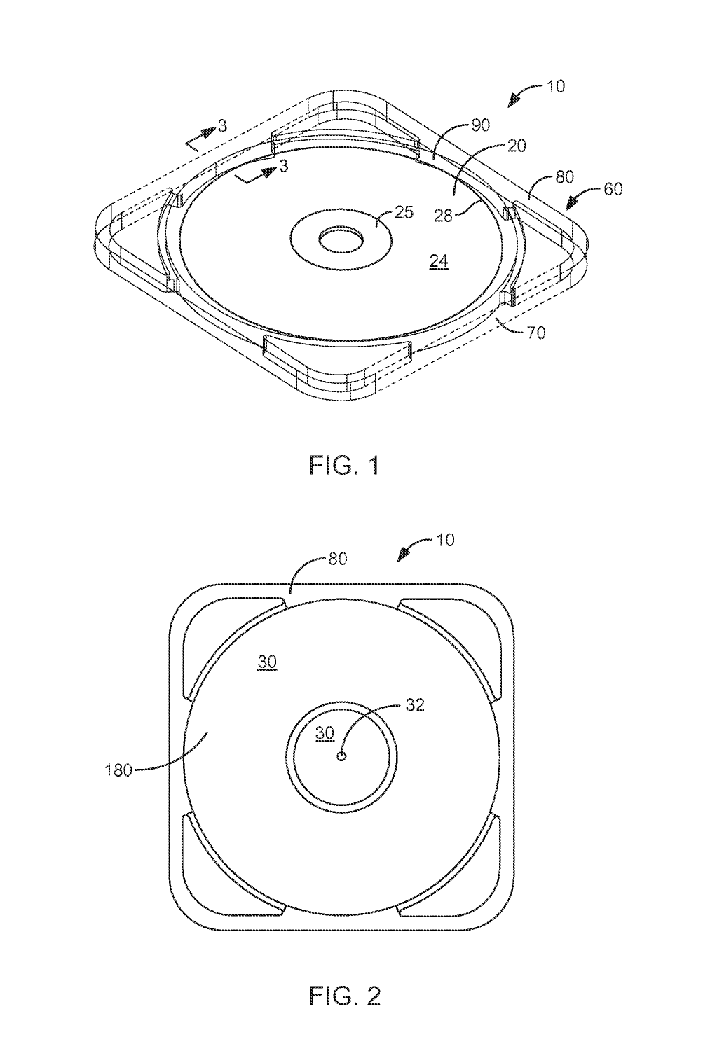

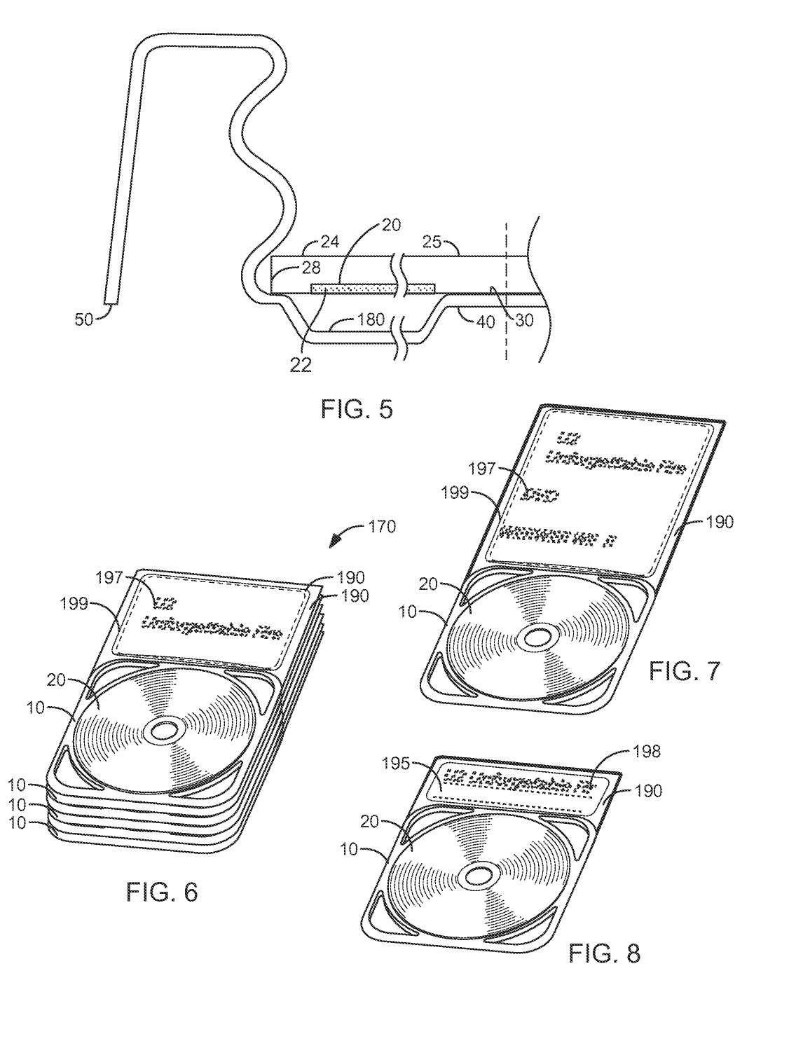

With regard to the figures, FIGS. 1 and 2 illustrate a tray 10 for storing a media disk 20, such as a DVD, compact disc, CD-ROM, or the like. The media disk 20 is preferably of the type having a data portion 22, a central hub 25, a top surface 24 and an outer peripheral edge 28 (FIGS. 1 and 5).

The tray 10 comprises a top surface 30, a bottom surface 40, and at least one peripheral edge 50 connecting the top and bottom surfaces 30,40, as illustrated in FIGS. 2 and 5. The tray 10 is preferably made from a sheet of resilient plastic material, such as vacuum-formed PVC or other suitable plastic, resilient material.

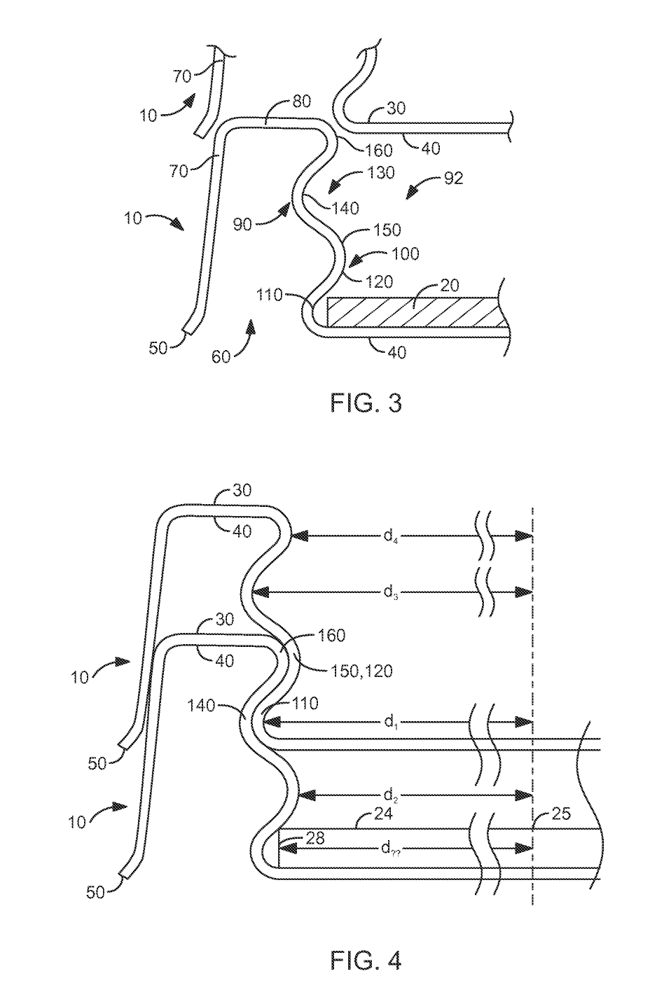

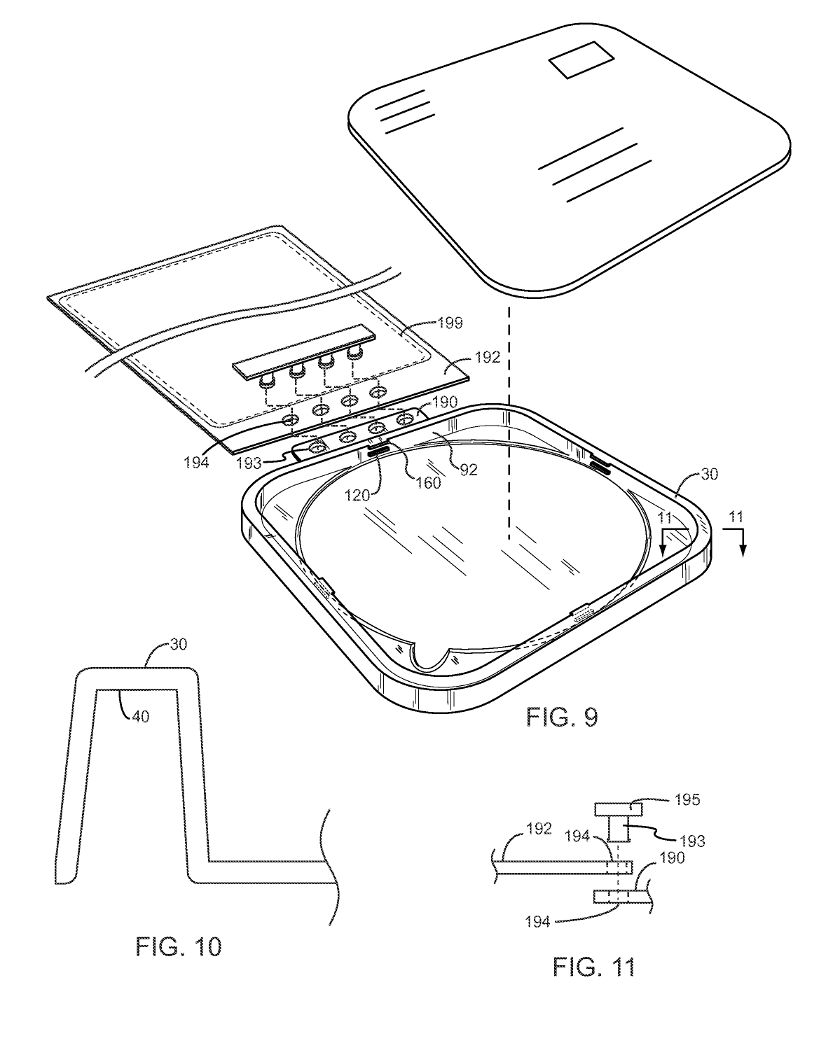

A generally U-shaped edge portion 60 of the tray 10 (FIG. 3) includes an outer side 70, an upper side 80, and an inner side 90. The inner side 90 forms a generally annular wall 92 that includes a lower trough 100 that has a valley 110 with a larger diameter d₁ than the diameter dₘ of the media disk 20 (FIG. 4). The lower trough 100 has at least one ridge 120 with a diameter d₂ that is smaller than the diameter dₘ of the media disk 20. In the embodiment of FIG. 9, the lower trough 100 is comprised of at least two opposing lower troughs 100 that together have at least one ridge 120 that spans a distance smaller than the diameter dₘ of the media disk 20. As such, the media disk 20 may be selectively captured within the lower trough 100 of the tray 10, the outer side 70 and the inner side 90 of the U-shaped edge portion 60 each being slightly tapered towards the upper side 80 such that a plurality of the trays 10 may be nestably stacked together (FIG. 6).

In one mode of the invention illustrated in FIGS. 3 and 4, the inner side 90 of the U-shaped edge portion 60 of the tray 10 further includes an upper trough 130 having a valley 140 with a larger diameter d₃ than the diameter d₁ of the valley 110 of the lower trough 100. Further, the upper trough 130 has an upper ridge 160 that has a diameter d₄ that is smaller than the diameter d₁ of the valley 110 of the lower trough 100. As such, the upper trough 130 of the tray 10 may selectively receive the lower trough 100 of another such tray 10 therein in a nested, selectively locked stack 170 of such trays 10 (FIG. 6).

Each such stacked tray 10 may include at least one media disk 20 captured between successive trays 10. In this way a storage system for a plurality of the media disks 20 that comprises a plurality of the trays 10 may be formed by compressing each tray 10 into each next adjacent tray 10. For n media disks 20, for example, n+1 trays 10 would be used in the stack 170, with the top-most tray 10 acting as a top cover. If desired, two media disks 20 may be held by each tray 10, but in such an embodiment each tray 10 may not snap securely to the next adjacent tray 10 (not shown). However, in such a configuration, to hold n disks, n/2+1 trays 10 would be used. Air vent 32 may be formed in a center portion of each tray 10, for example, to allow air trapped between each tray to escape therefrom (FIG. 2).

In one embodiment of the invention, illustrated in FIG. 5, the top and bottom surfaces 30,40 of the tray 10 further include an annular trough 180 immediately below the data portion 22 of the media disk 20 when the media disk 20 is captured in the lower trough 100. As such, the top surface 30 of the tray 10 contacts the media disk 20 only proximate the central hub 25 and the peripheral outer edge 28 of the tray 10. When the tray 10 is nestably stacked and locked to another such tray 10 with the media disk 20 captured therebetween, preferably the bottom surface 40 of the other tray 10 is separated from the top surface 24 of the media disk 20. In this manner each disk 20 stored in such a storage system is held away from contacting any of the trays 10 proximate its data portion 22, thereby protecting the media disk 20 from scratches on its data portion 22.

In an alternate embodiment of the invention, illustrated in FIGS. 6-8, each tray 10 further includes a resilient media index portion 190 projecting away from the peripheral edge 50 of the tray 10 at the outer side 70 of the U-shaped edge portion 60. The media index portion 190 includes an area 195 adapted to receive markings 198 thereon for indicating the characteristics, such as contents, of the media disk 20 (FIG. 8). The area 195 may be adapted to temporarily receive non-permanent markings 198 (FIG. 8) from a dry-erase pen, a pencil, a ballpoint pen, or the like (not shown). Alternately, the area 195 may be adapted to receive a label, decal, printed media information 197 (FIGS. 6 and 7) or the like, and may include an envelope 199, transparent pocket, or the like (FIGS. 6, 7, and 9). The envelope 199 may be ultrasonically welded to the media index portion 190, or a projecting tab (not shown). As such, in the stack 170 of trays 10 and media disks 20, the index portions 190 of the trays 10 may be flipped through until a desired media disk 20 is located, for example. The media index portion 190 may further include aperture 194 that are releasably engage to apertures 194 of an index card 192 (FIG. 9) with an attachment tab 196 having lugs 193 (FIG. 11) that traverse the apertures 194. The index card 192 is sized to accommodate liner notes (not shown) accompanying various media disks 20. For example, an index card 192 sized for DVD media disks 20 accommodates DVD liner notes (not shown) that typically are included with DVDs.

An alternate, preferred mode of the invention is illustrated in FIGS. 9-10. To remove the media disk 20 from the tray 10 in such an embodiment, opposing corners of the tray 10 may be bent towards each other, the tray 10 folding along a diagonal axis (not shown) to expose an edge of the media disk 20 for grasping. In such an embodiment, the lower trough 100 and the upper trough 130 are only included along a portion of the generally annular wall 92, for example, in four areas as shown in FIG. 9.

Preferably the top and bottom surface 30,40 of each tray 10 and the outer side 70 of the U-shaped edge portion 60 are each generally rectangular in shape in plan view, as illustrated in FIG. 2. However, other suitable shapes for the tray 10 may be devised, such as circular, oval, square, octagonal, or the like. The U-shaped edge portion 60 of each tray 10 acts like a dampening spring to absorb impact to the tray, such as if dropped, for example. Further, a resilient mailing insert 200 (FIG. 9) may be included that selectively covers the media disk 20, being retained within the try 10 by friction or, additionally, adhesive tape or the like. As such, the media disk 20 may be secured into the tray 10 with the mailing insert 200 and mailed through the postal system.

While a particular form of the invention has been illustrated and described, it will be apparent that various modifications can be made without departing from the spirit and scope of the invention. For example, the exact shape of the U-shaped edge portion 60 may be modified with additional troughs, ridges, or the like (not shown). Also, the tray 10 may be made from different colors of resilient plastic material for aesthetic or sorting purposes. Accordingly, it is not intended that the invention be limited, except as by the appended claims.

What is claimed is:

1. A tray for storing a media disk comprising a top surface, a bottom surface, and at least one peripheral edge connecting the top and bottom surfaces, a generally U-shaped edge portion of the tray comprising an outer side, an upper side, and an inner side, the inner side forming a generally annular wall that includes a lower trough having a valley with a larger diameter than the diameter of the media disk, the lower trough having at least one ridge spanning a distance smaller than the diameter of the media disk, the media disk being selectively capturable within the lower trough, the outer side and inner side each being slightly tapered toward the upper side such that a plurality of trays may be nestably stacked together.

2. The tray of claim 1 wherein the inner side of the U-shaped edge portion of the tray further includes an upper trough having a valley with a larger diameter than the diameter of the valley of the lower trough, the upper trough having a lower ridge in common with the at least one ridge of the lower trough, the upper trough having an upper ridge with a diameter smaller than the diameter of the valley of the lower trough, whereby the upper trough of the tray may selectively receive the lower trough of another such tray therein in a nested, selectively locked stack of such trays, the media disk being captured between each tray.

3. A storage system for a plurality of media disks comprising a plurality of the trays as recited in claim 2, each tray nested and selectively locked in a stack of such trays.

4. The storage tray of claim 2 wherein the media disk is of the type having a data portion, a central hub, and an outer peripheral edge, and wherein the top and bottom surfaces of the tray further includes an annular trough immediately below the data portion of the media disk when the media disk is captured in the lower trough, the top surface of the tray contacting the media disk only proximate the hub and the peripheral top edge.

5. The storage tray of claim 4 wherein with the tray nestably stacked and locked to the other tray, the bottom surface of the other tray is separated from a top surface of the media disk.

6. The storage tray of claim 1 wherein the tray further includes a resilient media index portion projecting away from the peripheral edge of the tray at the outer side thereof, the media index portion including an area adapted to receive markings thereon for indicating the contents of the media disk.

7. The storage tray of claim 6 wherein the media index portion includes a pocket for storing printed media disk information.

8. The storage tray of claim 1 wherein the top surface and bottom surface of the tray and the outer side of the U-shaped edge portion are each generally rectangular in shape in plan view.
